(19) United States
(12) Patent Application Publication
(10) Pub. No.: US 2022/0126947 A1
(43) Pub. Date: Apr. 28, 2022

(54) Vehicle, In Particular A Lightweight Vehicle

(71) Applicant: Gunter Rood, Remscheid (DE)

(72) Inventor: Gunter Rood, Remscheid (DE)

(21) Appl. No.: 17/296,027

(22) PCT Filed: Nov. 22, 2019
(86) PCT No.: PCT/EP2019/082220

§ 371 Date: May 21, 2021

(30) Foreign Application Priority Data
Nov. 23, 2018 (DE) 10 2018 009 184.9
Jun. 11, 2019 (DE) 10 2019 115 811.7
Jun. 27, 2019 (DE) 10 2019 117 433.3

(51) Int. Cl. B62M 6/40; B62K 13/08; B62K 19/10; B62K 3/00; B62K 7/02; B62J 17/083

(52) U.S. Cl. CPC B62M 6/40; B62K 13/08; B62K 19/10; B62K 2015/001; B62K 7/02; B62J 17/083; B62K 3/005

(57) ABSTRACT

The invention relates to a vehicle, in particular a lightweight vehicle. The vehicle can be converted from a driving configuration to a seating configuration by reducing the distance between a front wheel structure and a rear wheel structure.

### CROSS-REFERENCE TO RELATED APPLICATIONS

This application is the U.S. national stage application of International Application PCT/EP2019/082220, filed Nov. 22, 2019, which International Application was published on May 28, 2020, as International Publication WO 2020/104651 in the German language. The International Application claims priority to German Application Nos. 10 2018 009 184.9, filed Nov. 23, 2018; 10 2019 115 811.7, filed Jun. 11, 2019; and 10 2019 117 433.3, filed Jun. 27, 2019. The International Application and German Applications are hereby incorporated herein by reference, in their entireties.

### FIELD

The invention relates to a lightweight vehicle.

### BACKGROUND

In terms of ecological as well as economic aspects, serious changes are taking place very quickly in the field of transportation. This applies in particular to passenger transport. In order to meet current and future requirements, it is necessary to find a good compromise between the general need for sustainability and the individual desire for comfort and safety. Increased use of local public transport services often fails due to a lack of acceptance among large sections of the population. The aspect of the so-called “first and last mile” is seen as particularly problematic. While central locations are generally well connected to the public transport network, the journey from the actual starting point, such as the home, to a central transport hub, as well as from such a hub to the final destination of a trip, is generally associated with increased effort. This is especially true in rural areas, but even affects metropolitan areas. Often, the effort to cover the first and last leg of a journey on foot or by changing trains several times is considered disproportionately high. A correspondingly extensive expansion of the existing public transport infrastructure to ensure accessibility almost everywhere with minimal effort is ruled out for economic reasons. As a result, even fundamental advocates of public transport often prefer private motorized transport (MIV).

Combined solutions, for example by traveling part of the way by bicycle and taking the bicycle on public transport, often fail because it is by no means possible to take a bicycle or a comparably sized means of transport on all public transport without problems. This is often already problematic for individual transport. The additional transport of an expected large number of bicycles, scooters or the like is ultimately not feasible with the current infrastructure of public transport. In any case, a bicycle or the like ultimately represents a comparatively bulky piece of luggage during locomotion by public transport. It is true that a folding bicycle, for example, can be folded for space-saving transport. However, this process is usually labor-intensive and time-consuming and is therefore hardly worthwhile when using public transport for short or medium distances.

Alternative systems that allow for the collective transportation of individual vehicles, similar to a motorail train, are generally expensive and insufficiently available due to the associated space requirements.

Another circumstance that reduces the acceptance of public transport among the population is the frequent lack of cleanliness of public transport. Lack of time and cost pressure lead to no or insufficient cleaning of the passenger area, especially in mass transit. Soiled seats or seats subject to vandalism on buses or trains do not meet the comfort requirements of many passengers.

Against this background, it is an object of the present invention to increase the accessibility and usability of public transportation and, at the same time, to substantially increase travel comfort for passengers.

### SUMMARY

The aforementioned object is solved by a vehicle with the features according to claim 1. Advantageous embodiments are subject of the subclaims.

According to the invention, the vehicle is reversibly transferable from a driving configuration to a seating configuration, wherein the vehicle has a seating surface in the seating configuration and wherein the distance between the front wheel assembly and the rear wheel assembly of the vehicle is smaller in the seating configuration than in the driving configuration.

The distance between the wheel assemblies in the seating configuration is preferably dimensioned in such a way that a stable standing of the vehicle in the seating configuration is ensured. This applies in particular to the case where a user sits on the seating surface of the vehicle in the seating configuration. A stable stance is to be assumed in particular if overturning of the vehicle only occurs when the vehicle tilts against the vertical axis by at least 10°, preferably at least 20°.

The possibility of converting the vehicle into a space-saving seating option with little effort allows, in particular, the vehicle to be taken along on public transport without requiring significantly more space than an ordinary seat on a bus or train would take up anyway. As a result, the present invention allows seamless integration into local and/or long-distance public transportation services by using public transportation cars that are provided at least partially empty or without seats. A passenger who has traveled with the vehicle according to the invention, for example to a public transport stop, can thus use his or her vehicle in the public transport system as his or her own seating. In contrast, there are no further space requirements, in particular for stowing the vehicle, as in the case of a bicycle or the like. This is particularly advantageous in the case of many vehicles. As a result, a major hurdle to linking public and individual passenger transport is removed.

Using one's own seat also eliminates the problem of passengers having to sit on dirty or damaged seats of the means of transport. In addition, by using an individual, preferably ergonomic seat, the seating position and thus the comfort for the user can be adjusted and is maintained during the journey by public transport. This has particular advantages for people who have special requirements for their seat for medical reasons.

It goes without saying that the vehicle according to the invention offers advantages not only in local and long-distance public transport. The efficient use of non-public carrier vehicles, for example in the private sector or in the transport of security and emergency personnel, is also made possible by the invention. However, widespread use in public passenger transport, especially in local public transport, has the greatest influence on positive ecological development. Therefore, this application is particularly emphasized here. All embodiments and advantages of the invention described with respect to the public sector apply in the same or corresponding manner to the non-public sector.

Preferred embodiments of the invention are described below. The vehicle according to the invention may have one or more of the described features in any combination.

The vehicle may have an adjustment device for changing the distance between the front wheel assembly and the rear wheel assembly.

In addition to the driving configuration and the seating configuration, the vehicle is convertable into a transport configuration. Preferably, the distance between the front wheel assembly and the rear wheel assembly is smaller in the transport configuration than in the seating configuration and/or the external dimensions of the vehicle are further reduced in at least one dimension compared with the seating configuration and the driving configuration. In particular, projecting parts of the structure, for example a seating surface, can be removed, folded in and/or retracted for this purpose, resulting in an overall more compact shape of the vehicle in the transport configuration.

The distance between the front wheel assembly and the rear wheel assembly in the transport configuration can be less than the width of the vehicle.

The vehicle can have a multi-part body with at least two vehicle sections connected to one another, in particular in an articulated and/or displaceable manner, preferably with the front wheel body being assigned to a front vehicle section and the rear wheel body being assigned to a rear vehicle section.

Reducing the wheelbase ultimately reduces the footprint of the vehicle when it is transferred from the driving to the seating configuration. This significantly reduces the space required in any collective transport vehicle.

The drive device can be designed as an electric motor. This enables the vehicle to be propelled almost silently.

A fuel cell can be assigned to the drive device.

In particular, the drive device can implement a plurality of drive concepts in parallel in the sense of a hybrid drive.

The drive device acts in particular on the wheels of the rear or front wheel assembly. Preferably, both at least one wheel of the front wheel assembly and at least one wheel of the rear wheel assembly, especially preferably all wheels, are driven.

The drive device may be configured to accelerate the vehicle to a speed of at least 5 km/h, preferably at least 10 km/h, preferably at least 25 km/h, more preferably at least 45 km/h.

Alternatively or additionally, the vehicle can also be configured not to exceed a certain maximum speed. This is done in particular by means of a corresponding cruise control. Preferably, the maximum speed is a maximum of 6 km/h, preferably a maximum of 12 km/h, further preferably a maximum of 20 km/h. Depending on the typical application situation of the vehicle, a higher limitation of the maximum speed, for example to a maximum of 30 km/h, a maximum of 50 km/h or a maximum of 60 km/h, can also be provided.

An energy storage device, in particular a battery, an accumulator or the like, can be provided from which the drive device is supplied with energy. A control device can be provided to monitor the state of charge and any charging process. The energy accumulator can be charged, in particular, by connecting the vehicle to the supply network, for example to a standard household socket. Charging and/or diagnostics of the energy storage device can be performed in particular after the vehicle has been coupled to a collective transport means by means of a suitably designed coupling device. The energy storage device can also be formed or supplemented by a fuel tank.

The energy storage device preferably has a sufficient storage volume to allow driving without recharging, refilling or replacing the energy storage unit over a distance of at least 50 km, preferably at least 100 km.

The distance between the front wheel assembly and the rear wheel assembly in the driving configuration can be at least 1 m, preferably at least 1.5 m.

The vehicle may have an open structure or comprise a passenger cell. The passenger cell can be completely or partially removable and/or lockable.

In the driving configuration, the vehicle may have a body shape of a scooter, in particular a two-wheeled scooter, a runabout or buggy, or a tricycle. In addition, a go-kart-like body shape is also preferred.

The vehicle may comprise one seat, in particular a centrally located seat. In addition, a design with a plurality of seats is also possible within the scope of the invention. Alternatively or additionally, an open or preferably separately lockable storage space for transport material may be provided.

In particular, the seat comprises a seating surface and a seating whip. Preferably, the seat is at least partially usable in both the driving configuration and the sitting configuration by a person sitting on the seat surface. Preferably, the seat position and/or the seat shape is adjustable.

Control devices are provided in particular for controlling the vehicle during driving. These include, for example, a steering system, preferably in the form of a steering knuckle. The steering can be operated mechanically via a steering column and steering means, or it can be controlled electronically.

In principle, the vehicle is not limited to a specific steering technology. Alternatively or additionally, steering technologies known from recumbent bicycles or velomobiles, for example, can be implemented, in particular a tank steering system, a bottom steering system, a top steering system or a UDK (“around the knees”) steering system or a so-called aero steering system.

Similarly, control elements for accelerating and decelerating the vehicle can also be based on a mechanical or electronic operating principle or implement a mixture of both concepts. In particular, mechanically acting elements such as a steering column and/or pedals are designed in such a way that they can be retracted and/or swung away during the transition from the driving configuration to the seating configuration and/or transport configuration.

A coupling device can be provided for coupling the vehicle to a corresponding coupling receptacle, in particular a coupling receptacle of a collective transport means. The collective transport means is in particular a bus, a train, a ferry or a cable or gondola lift. The coupling device can be designed, in particular standardized, for coupling the vehicle to several different collective transport means.

The coupling device is in particular part of a coupling system. The coupling system may comprise, on the side of the collective transport means, a single receptacle for the coupling device or a rail system for connection to one or more coupling devices. The coupling device as such may further comprise a hook arrangement for connection to a corresponding receptacle. Alternatively or additionally, the coupling device can be designed to be connected to a receptacle, in particular a standardized receptacle, according to the principle of a docking station.

By using a collective transport vehicle, greater distances can be covered in a more economical and ecologically compatible manner than would normally be possible by private transport. In this context, the vehicle according to the invention serves in particular to bridge the so-called “first and last mile”, i.e. in each case the distances between the exact starting point or destination and the access point to the collective transport means, which serves as a means of transport for the main part of the distance to be covered between the starting point and destination.

The vehicle can have a handle element that can be pulled out in particular.

A locking device for locking at least one wheel, preferably all wheels, can be provided.

The locking device can be activated by transferring the vehicle to the seat configuration.

The locking device can be activated and/or deactivated alternatively or additionally by an operating device arranged in particular on the handle element.

The vehicle may have a preferably extendable or swing-out support for stabilizing the vehicle in a standing position, particularly in the transport configuration.

### BRIEF DESCRIPTION OF THE DRAWINGS

Further aspects of the invention can be found in the following description of embodiments. In this regard, all features described or shown in drawings constitute independent aspects of the invention, regardless of their combination in the embodiments shown or in the claims.

It shows:

FIG. 1 is a perspective schematic representation of a vehicle according to the invention in a preferred embodiment,

FIG. 2 is a side view of the vehicle of FIG. 1,

FIG. 3 is a perspective schematic view of part of the vehicle of FIG. 1,

FIG. 4 is a perspective schematic representation of a further preferred embodiment of the vehicle according to the invention,

FIG. 5 is a side view of the vehicle of FIG. 4 in a driving configuration,

FIG. 6 is a side view of the vehicle of FIG. 4 in a seating configuration,

FIG. 7 is a side view of the vehicle of FIG. 4 in a transport configuration, and

FIG. 8 is a perspective schematic representation of a further preferred embodiment of the vehicle according to the invention.

### DETAILED DESCRIPTION

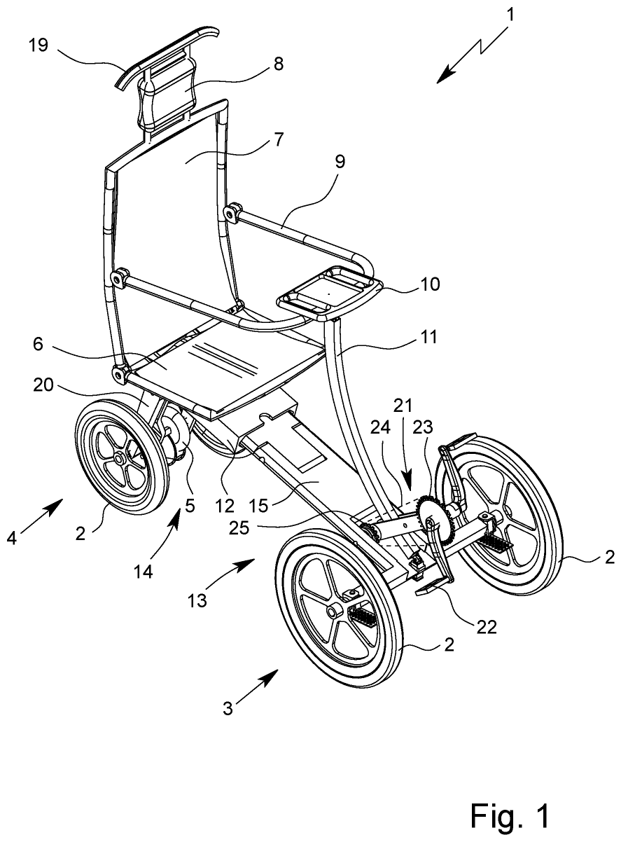

FIG. 1 shows a vehicle 1 according to the invention in a driving configuration. The preferred embodiment of the vehicle 1 shown has a total of four wheels 2, each of which is distributed in pairs over a front wheel assembly 3 and a rear wheel assembly 4.

However, each wheel assembly 3, 4 can also have a different number of wheels 2. Alternatively, for example, an embodiment in which the rear wheel assembly 4 has only one wheel 2 is also preferred.

The vehicle 1 has a drive device 5, which is in particular an electric motor, preferably an electric hub motor. Alternatively or additionally, an internal combustion engine can also be provided to effect propulsion of the vehicle 1.

An energy storage device not shown in detail can be provided to supply energy to the drive device 5. This may be a rechargeable and/or replaceable battery in particular and/or a refillable and/or replaceable fuel tank. Although an electric drive is preferred for ecological reasons, the energy required for locomotion can also be provided alternatively or additionally from fossil fuels, for example by gasoline, diesel fuel, natural gas and/or LPG.

Alternatively or additionally, the energy supply of the vehicle 1, in particular of the drive device 5, can also be provided by means of a photovoltaic device and/or by means of a fuel cell.

The vehicle 1 has a seating surface 6 on which a user, in particular a driver of the vehicle 1, can sit. To increase safety and comfort for the user, the vehicle 1 may further comprise a whip 7 and/or a headrest 8.

The seating surface 6, the whip 7 and/or the headrest 8 are preferably adjustable in position and/or inclination. Preferably, the elements concerned can be adjusted separately. Fixing takes place in particular by means of a latching joint and/or by a positive locking element.

In the driving configuration shown, the driver sitting on the seating surface 6 is at least partially surrounded by a safety bracket 9. The safety bracket 9 prevents the driver from falling out of the vehicle 1 when lateral accelerations occur, for example when driving through curves. In addition, the safety bracket 9 can also be used to attach further functional devices of the vehicle 1.

The vehicle 1 is preferably controlled by means of a control device 10. In particular, the control device 10 can be used to change the direction of travel of the vehicle 1 during travel in the sense of steering. Alternatively or additionally, the control device 10 can serve to control the drive device 5 so that, for example, the driving speed can be set.

Furthermore, other functional devices of the vehicle 1 can also be controlled, activated and/or deactivated by means of the control device 10. The control device 10 serves in particular as a user interface between the vehicle 1 and the driver or user. Preferably, the control device 10 has a corresponding input means and/or a display device for this purpose. It is understood that different functions of the control device 10 do not necessarily have to be assigned to the same component.

In particular, the control of functions relating to locomotion, for example steering and/or speed, can be affected by a structurally different component than the influencing of further functional devices of the vehicle 1. Preferably, a separate steering device, in particular a steering wheel, is provided at least for the steering of the vehicle 1.

The steering of the vehicle 1 is preferably carried out using a so-called Ackermann arrangement, which ensures a steering angle corresponding to the respective curve radius for each wheel 2 when passing through a curve.

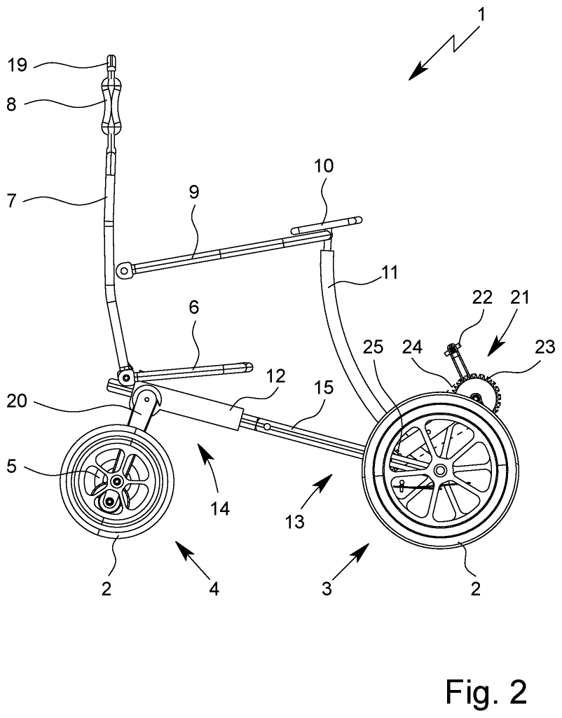

In the embodiment shown in FIGS. 1 and 2, the control device 10 is supported by an optional holding element 11. By means of the holding element 11, in particular a mechanical and/or electronic connection of the control device 10 with further functional devices of the vehicle 1 is established. The holding element 11 may, for example, comprise or include a steering column and/or a steering shaft. Alternatively or additionally, the holding element may also comprise a data line and/or a line for supplying power to the control device 10. The holding element 11 may also merely serve as a support for such a connecting line, a steering column and/or a steering shaft.

The control device 10 can alternatively or additionally be connected to other devices of the vehicle 1. In particular, if only an electronic connection is required, the control device 10 can ultimately be attached to any component of the vehicle 1, especially to the safety bracket 9.

Furthermore, a wireless connection of the control device 10 with devices of the vehicle 1 can also be provided. Preferably, the control device 10 is designed to be detachable and/or can be used by the user as a separate component that is connected to the other components of the vehicle 1 only via a connection, in particular a wireless connection, for data transmission and/or power transmission.

In a preferred embodiment, the control device 10 is to be held by the user as a separate component from the rest of the vehicle 1 for operation and is, preferably, inserted into a corresponding holder or attached to a holding element 11 for charging an accumulator of the control device 10. Charging of an accumulator of the control device 10 is then performed in particular inductively.

Alternatively or additionally, a holder for a tablet computer and/or smartphone can be provided.

In particular, the vehicle 1 can be designed at least in part to be controlled by means of a tablet computer and/or a smartphone. A preferred function controlled in this way is, for example, the unlocking or release of the vehicle 1 by a user identification. Furthermore, function settings can be made by means of a tablet computer, a smartphone and/or the control device 10. In addition, it is possible to read out technical parameters, such as distance traveled, charging or filling status of an energy storage unit or error messages, in a corresponding manner.

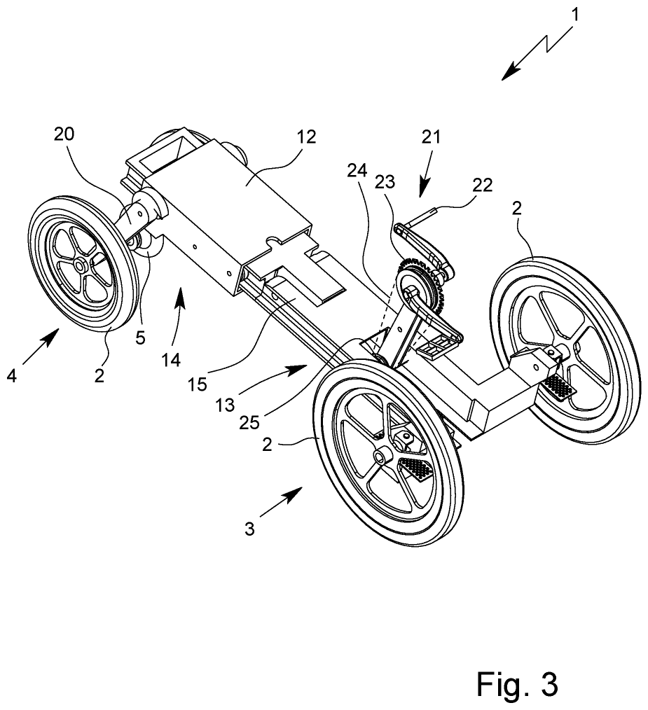

FIG. 3 shows only the lower part of the vehicle 1. For the sake of clarity, the upper body parts, for example the seating surface 6 and associated components as well as the holding element 11, have been omitted in this illustration. This illustration can be used to explain the structure and operation of the relevant parts of the vehicle 1. In particular, the parts shown form a chassis of the vehicle 1.

The vehicle 1 preferably has an adjustment device 12 by means of which the distance between the front wheel assembly 3 and the rear wheel assembly 4 can be reduced. This allows the vehicle 1 to be converted from a driving configuration to a seating configuration. The reduced spacing of the wheel assemblies 3, 4 significantly reduces the space requirement in relation to the footprint of the vehicle 1, so that the vehicle 1 can be easily placed in a public transport vehicle or a collective transport vehicle at a location intended for this purpose. Despite the reduced space requirement, the design of the chassis consisting of front wheel assembly 3 and rear wheel assembly 4 ensures that the vehicle 1 is stable in the seating configuration.

Locomotion with the vehicle 1 is preferably not provided in the seat configuration. For this purpose, one or more wheels 2 can be locked by means of a locking device. Unintentional movement, slipping or rolling away of the vehicle 1 in the seat configuration is thereby prevented. Preferably, the locking device can be activated by transferring the vehicle 1 to the seating configuration.

Preferably, the vehicle 1 has a front vehicle section 13 and a rear vehicle section 14, wherein the front wheel assembly 3 is associated with the front vehicle section 13 and the rear wheel assembly 4 is associated with the rear vehicle section 14.

The vehicle sections 13, 14 are connected to one another in particular in an articulated and/or movable manner. Preferably, the front vehicle section 13 has a base frame 15 for this purpose, which cooperates with the adjustment device 12 to connect the vehicle sections 13, 14.

As can be seen in particular from the side view of the vehicle 1 shown in FIG. 2, the base frame 15 in the embodiment described here has a straight shape and can be pushed into the complementary shaped adjustment device 12. This brings the front wheel assembly 3 closer to the rear wheel assembly 4, so that the dimensions of the vehicle 1, in particular with regard to length, are significantly reduced.

The base frame is preferably made of or has a correspondingly structurally strong material. In particular, a material made from renewable raw materials is used.

The transfer of the vehicle 1 from the driving configuration to the seating configuration is explained below with reference to a further preferred embodiment of the vehicle 1.

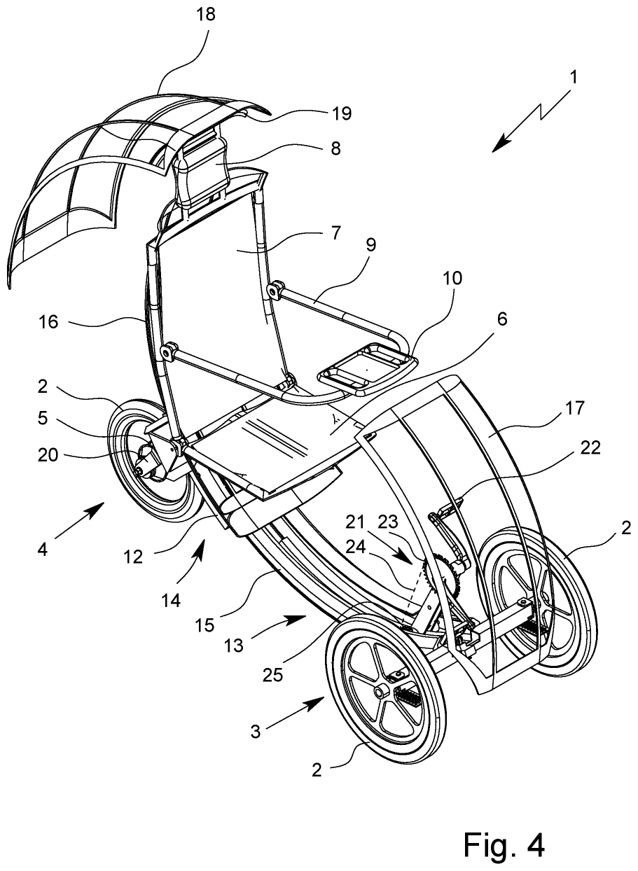

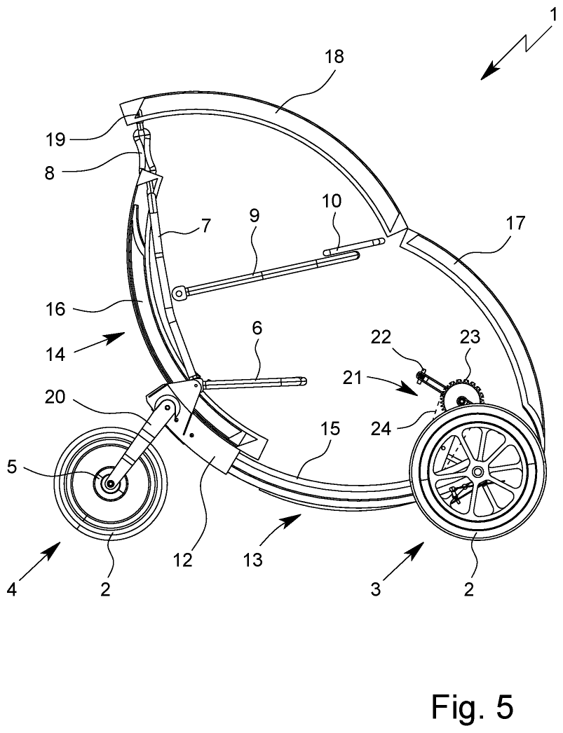

The vehicle configuration shown in FIGS. 4 to 7 provides for the base frame 15 and the adjustment device 12 to have a curved shape. This is particularly evident from the side view of FIG. 5, which shows the vehicle 1 in driving configuration. Also in this embodiment, the vehicle 1 has a front vehicle section 13 and a rear vehicle section 14.

In addition to the adjustment device 12 and the rear wheel assembly 4, the rear vehicle section 14 is also assigned in particular a seat frame 16. Preferably, the seating surface 6, the whip 7 and/or the safety bracket 9 are mounted on the seat frame 16 in an articulated manner.

The front vehicle section 13 is assigned in particular the base frame 15, the front wheel assembly 3 and/or the holding element 11.

Preferably, the seat frame 16 serves at least substantially as a support for those body components which serve to support the user. In particular, the base frame 15 provides the vehicle 1 with structural stability and preferably supports all the essential components of the vehicle 1. By connecting the base frame 15 to the seat frame 16 via the adjustment device 12, flexibility is maintained despite the high level of stability, in particular with regard to the convertibility of the vehicle 1 from the driving configuration to the seating configuration and vice versa, i.e. a use of the vehicle 1 either as a means of transport or as a seating option.

Preferably, the seat frame 16, the structures relating to the seat, i.e. seating surface 6, whip 7 and headrest 8, the adjustment device 12 and/or the rear wheel assembly 4 are guided and/or displaceable on the base frame 15. In particular by means of a locking bolt and/or an eccentric lever, the corresponding components can be locked in different defined positions and/or in particular braced with respect to the base frame 15 with at least substantially no play.

To protect the driver from weather and other environmental influences, a shield is provided in the embodiment of the vehicle 1 shown in FIGS. 4 to 7, which has a lower disc 17 and a upper disc 18. The discs 17, 18 can be made of the same or different materials. Preferably, polycarbonate and/or PMMA or a comparable material is used here.

The upper disc 18 preferably has a transparent area or is designed to be transparent as a whole. Alternatively or additionally, the upper disc 18 may also have a recess and/or a viewing window. The lower disc 17 may be formed to be completely non-transparent, in order to form a view protection from the outside onto the driver and the lower area of the vehicle 1. In addition, however, the lower disc 17 may also be partially or completely transparent.

In particular, the lower disc 17 is associated with the front vehicle section 13 and may further be attached to the base frame 15, for example by a snap-in and/or plug-in connection. The upper disc 18 is preferably mounted in such a way that it is held by a support device 19. Alternatively or additionally, the upper disc 18 can also be fastened with or to the lower disc 17 and/or to the safety bracket 9.

Preferably, the upper disc 18 is pushed in over the support device 19 for assembly until it reaches the lower disc 17. In the final position, the upper disc can be fixed, for example, by latching and/or clamping. In particular, the upper disc 18 is fixed to the safety bracket 9, preferably by a frictional connection, a latching connection and/or a positive connection. In addition, it is also possible to use a positive-locking fixing element to fix the lower disc 17 and/or upper disc 18.

As an alternative to the multi-part design of the shielding presented here, in particular in the form of the lower disc 17 and the upper disc 18, a single-part design can also be provided, in which a single disc is provided, in particular only one lower disc 17 or one upper disc 18, depending on the assignment.

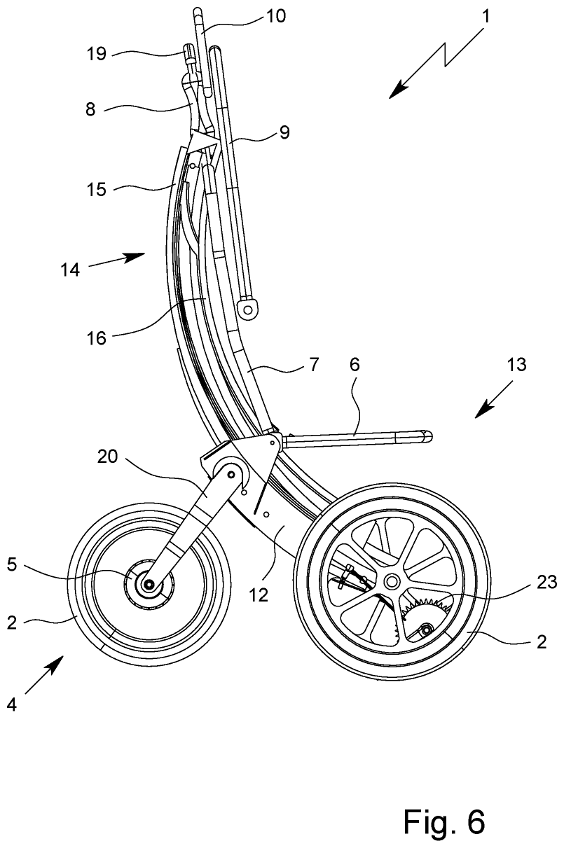

The transfer of the vehicle 1 from the driving configuration shown in FIG. 5 to the seat configuration shown in FIG. 6 is carried out in particular by pushing the base frame 15 into the adjustment device 12. In the curved design of the base frame 15 and the adjustment device 12 as well as the seat frame 16 shown here, all interacting components preferably have at least substantially the same curvature. As a result, the inserted base frame 15 nestles against the seat frame 16 in the seat configuration with little play. In this way, a particularly compact shape of the vehicle 1 is achieved in the seat configuration.

The lower disc 17 and/or the upper disc 18 can be removed for transfer from the driving configuration to the seating configuration and arranged on the base frame 15 or seat frame 16 to save space. For this purpose, the disc 17, 18 in particular has at least substantially the same curvature as the base frame 15 or seat frame 16.

The holding element 11 or a steering column can be designed to swivel and/or, if necessary, have at least substantially the same curvature as the base frame 15. In this case, the holding element 11 or the steering column can easily be placed on the base frame 15 in a space-saving manner for transferring the vehicle 1 to the seating configuration before the distance between the front wheel assembly 3 and the rear wheel assembly 4 is reduced. Preferably, the base frame 15 has a corresponding receptacle for the holding element 11 or the steering column and/or a disc 17, 18.

Preferably, the steering is locked, in particular centrally, when the holding element 11 or the steering column is applied.

The relative position of the front vehicle section 13 and the rear vehicle section 14 or of the base frame 15 and the adjustment device 12 can preferably be fixed in defined positions. The fixing is carried out in particular by a latching means. Alternatively or additionally, fixing by a positive locking element, for example a locking bolt and/or a locking cotter pin, is also possible.

To transfer the vehicle to the seating configuration, the safety bracket 9 is preferably swiveled away and/or removed, in particular swiveled upward. In this way, a seating option is created for the user.

An ergonomic shape of the seating surface 6, the whip 7 and/or the headrest 8 provides a high level of comfort for the user. Thus, it is possible to sit on the vehicle 1 in seat configuration for longer distances. This makes the vehicle 1 particularly suitable as a seat on longer journeys, for example on long-distance public transport. However, the advantages of an ergonomically shaped personal seat are equally applicable in the field of public transport. In particular, commuters who cover short or medium distances on each trip, but frequently do so with high frequency, benefit from the corresponding design of the vehicle 1 according to the invention.

For fixed positioning of the vehicle 1, in particular in the seat configuration, a coupling device can also be provided as an alternative to or in addition to a fixing device, which allows the vehicle 1 to be coupled to a corresponding coupling receptacle. The coupling receptacle can be assigned to or be part of a collective transport means, for example a public transport means.

In addition, docking and positioning of the vehicle 1 on another fixed support, such as a grandstand, are also possible. Such an application is particularly suitable at event locations, in the cinema, in the theater, at concerts, in stadiums or at comparable locations. As a result, the user of the vehicle 1 in the driving configuration can drive up to the desired location and, by transferring the vehicle 1 to the seating configuration, create a seat for himself on which he can take a seat while observing an event or performance. For an event organizer, this eliminates in particular both the need to provide sufficient parking space for visitor vehicles and the need to provide full seating for the event space.

At public events, in event buildings or on event areas, corresponding coupling receptacles or docking devices are preferably provided for this purpose in order to secure the vehicles 1 of the visitors, in particular in the seating configuration. Alternatively or additionally, a connection for energy and/or data transmission to the vehicles 1 can also be established so that, for example, an energy storage device is charged during the event. A data transmission also makes it possible to involve the visitors in the event, for example by reproducing data on a display device of the vehicle 1. Additional content, such as subtitles, can thus be transmitted, for example, or interactive options, such as in the form of spectator voting, can be implemented.

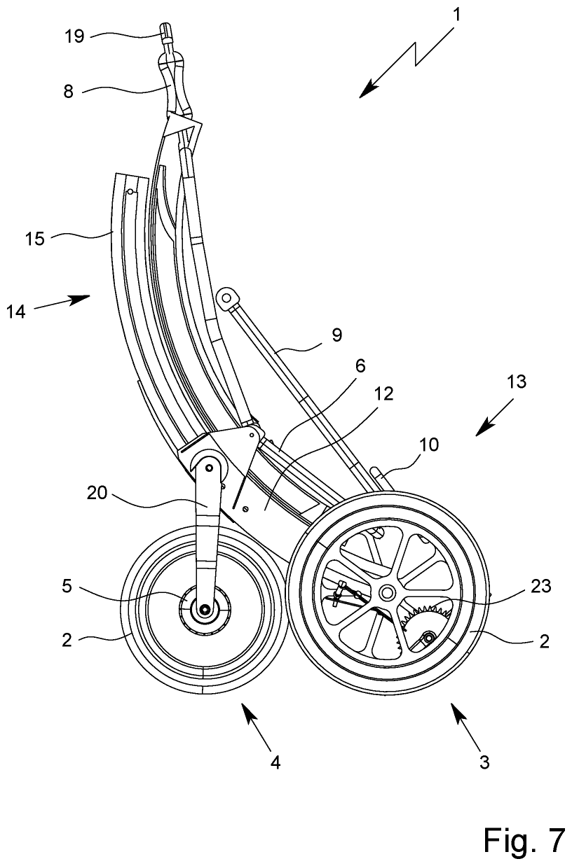

For simplified transport of the vehicle 1, in a preferred embodiment it can also be transferred to a transport configuration shown in FIG. 7. Compared to the driving configuration and the seating configuration, the transport configuration is characterized by an even more compact form of the vehicle 1. In particular, the vehicle 1 in the transport configuration can be pulled or pushed by the user similar to a trolley.

The transformability of the vehicle 1 by transferring it into different configurations is not only accompanied by advantages in transporting people over longer distances, but also leads to a high degree of multifunctionality in general. For example, vehicle 1 can be used as a shopping cart in which purchases are initially collected as usual and pushed through a store. After payment, however, reloading into a vehicle, such as a car or a cargo bike, is omitted. Instead, the vehicle 1 according to the invention is merely transferred from the transport configuration to the driving configuration and thus serves as a means of locomotion and transport for users and purchases. At the destination, there is preferably a further transfer to the transport configuration so that the purchases can be conveniently transported further. Thus, in particular, a transfer-free transport from the store to the home is possible. The corresponding advantages arise in a comparable manner if the vehicle 1 is used in the seating configuration in a means of public transport after shopping.

As a further possible application, the vehicle 1 can be used in golf, for example. There it can serve in the transport configuration as a trolley for a golf bag for transporting clubs. For this purpose, a corresponding receptacle for a golf bag or the like is preferably provided. Moreover, for covering further distances on the golf course, a separate golf cart can be dispensed with. The vehicle 1 according to the invention fulfills this purpose after being transferred to the driving configuration. In this context, the vehicle 1 can be converted back to the transport configuration and/or the seating configuration at any time with little effort, in order to serve as a trolley or as seating for the golfer.

The aforementioned application situations are merely listed as examples to explain the general multifunctionality of the vehicle 1 according to the invention. It is understood that the invention results in a multitude of further possible uses with respect to a flexible transport of persons and/or goods. If necessary, appropriate adaptations must be made to the vehicle 1 for certain applications, for example in the form of a special receptacle for add-on parts, a particularly large storage space, etc. However, these do not restrict the functionality according to the invention in particular.

Preferably, projecting parts, such as the seating surface 6, are retracted, folded in and/or removed for transfer to the transport configuration relative to the seat configuration. In the present example, the seating surface 6 is swiveled away downward. Alternatively or additionally, the safety bracket 9 is also swung away, retracted and/or removed, provided this has not already been done for transfer to the seating configuration. In the example shown here, the safety bracket 9 is pivoted downwards from the upwardly pivoted position of the seat configuration for transfer to the transport configuration and, in particular, lies at least substantially against the seating surface 6 and/or parallel to the seating surface 6.

In a preferred embodiment, the time to transfer the vehicle 1 from the driving configuration to the seating configuration is at most 60 seconds, preferably at most 30 seconds, from the seating configuration to the transport configuration is at most 20 seconds, preferably at most 10 seconds, and/or from the driving configuration to the transport configuration is at most 60 seconds, preferably at most 30 seconds.

The safety bracket 9 and/or the seating surface 6 can preferably be fixed in defined positions, in particular in the swung-out and/or swung-in state. A latching connection and/or a positively acting fixing element can be used for this purpose.

In the transport configuration, the vehicle 1 can preferably be easily moved by the user by means of a handle element. Such a handle element can be provided as a separate handle of the vehicle 1. In addition, however, a component of the vehicle 1 with a different function, in particular the support device 19, can also be used as a handle element.

To further reduce the dimensions of the vehicle 1 in the transport configuration, the distance between the front wheel assembly 3 and the rear wheel assembly 4 can preferably be further reduced compared to the seat configuration. For this purpose, the rear wheel assembly 4 can comprise or be attached to a wing 20, or be connected to the adjustment device 12 and or the seat frame 16 by means of a wing 20.

In particular, the wing 20 is articulated so that the rear wheel assembly 4 can be pivoted further towards the front wheel assembly 3, as shown in FIG. 7.

By means of a wing 20, the rear wheel assembly 4 can also be moved further towards the front wheel assembly 3 during the transfer from the driving configuration to the seating configuration. This gives the vehicle 1 more compact external dimensions. On the other hand, the inclination of the vehicle 1 or of the seating surface 6 and/or of the whip 7 relative to the ground is made steeper, in particular, so that a more comfortable and upright sitting posture is possible. Preferably, an offsetting of the wing 20 or of the rear wheel assembly 4 in the direction of the front wheel assembly 3 takes place automatically when the vehicle 1 is raised a little during the transfer to the seating configuration.

The wing 20 alternatively or additionally permits an increase in comfort through the function of vibration damping. For this purpose, the wing 20 can be mounted elastically or resiliently so that the rear wheel assembly 4 returns to a neutral position after deflection. In this way, shocks acting on the rear wheel assembly 4 while driving are not transmitted to the driver. A non-rigid connection between the rear wheel assembly 4 and the adjustment device 12 or the seat frame 16 thus ensures dynamic stabilization of the rear vehicle section 14.

For locomotion with the vehicle 1, a biomechanical drive option is provided as an alternative or in addition to the drive device 5. A pedal crank arrangement 21 is particularly suitable for biomechanically driven locomotion. On the one hand, a biomechanical propulsion of the vehicle 1 can be effected by the pedal crank arrangement 21 if the muscle force exerted on the pedals 22 is transmitted to at least one wheel 2, in particular at least one wheel 2 of the front wheel assembly 3. On the other hand, the pedal crank arrangement 21 may be designed such that a chain wheel 23 is moved by the actuation of pedals 22. The chain wheel 23 acts via a chain 24 on a chain pinion 25. The chain pinion 25 is in particular smaller than the chain wheel 23.

Instead of a chain 24, a connection between the chain wheel 23 and the chain pinion 25 can also be made by a toothed belt.

In a particularly preferred embodiment, the vehicle 1 is powered only by the energy contributed by the user. In this variant, locomotion is possible on the one hand in a particularly ecologically compatible manner. On the other hand, the physical activity additionally promotes the health of the user. This is basically the case with all biomechanically driven vehicles. However, the vehicle 1 according to the invention has a significantly higher suitability for everyday use in comparison. In particular, the range is significantly increased due to the problem-free use in conjunction with a carrier vehicle. This ultimately permits significantly more extensive and widespread use of the vehicle 1 according to the invention. The aforementioned advantages of biomechanically characterized mobility can thus now be brought to bear to such an extent that positive overall ecological and economic effects can be felt.

Furthermore, the additional use of muscle power can also interact with a drive device 5. Here, in particular, a drive form is preferred which is used in so-called pedelecs or e-bikes. Here, the biomechanical drive is supported as needed by the drive device 5, in particular a hub motor, whereby the extent of the support can be adjusted.

Preferably, the pedal crank arrangement 21 is adjustable in its inclination and/or its distance to the seating surface 6, in particular by means of a detent joint.

An arrangement for biomechanical propulsion of the vehicle 1, such as a pedal crank arrangement 21, can further be used in a recuperative manner, i.e. in particular for recharging an energy storage device by applied muscle power of the user.

The interaction of the pedal crank arrangement 21 and the drive device 5, in particular for recuperation and/or for interaction during propulsion, is preferably coupled via a toothed belt. A corresponding toothed belt arrangement is designed in particular in such a way that the toothed belt length can remain constant even if the distance between the front wheel assembly 3 and the rear wheel assembly 4 changes, i.e. the toothed belt continues to be tensioned. In particular, the toothed belt runs around the chain pinion 25 from which it is preferably driven. In addition, the toothed belt is coupled in particular to the rear wheel assembly 4, where it runs around a further, rear chain pinion, for example.

In a preferred embodiment of the vehicle 1, the drive device 5 is associated with the rear wheel assembly 4.

Preferably, further, the pedal crank arrangement 21 is designed such that the applied muscle force acts directly or indirectly on at least one wheel 2 of the front wheel assembly 3.

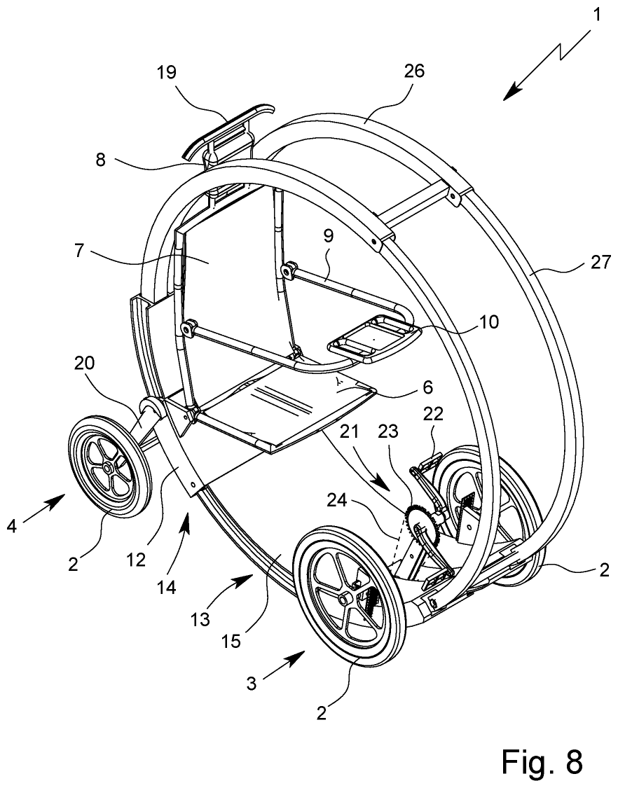

In the further preferred embodiment of the vehicle 1 according to the invention shown in FIG. 8, a preferably circumferential frame is provided which connects the rear vehicle section 14 and the front vehicle section 13 above or in front of the user. This creates a substantially enclosed shape of the vehicle 1. In particular, by enclosing an area around the driver, a kind of passenger cell is created which provides further safety for the driver, in particular in the event of collisions.

In the present case, the frame is of multi-part design and comprises a rear frame part 26 and a front frame part 27. It is understood that such a frame can also be of one-piece design. To transfer the vehicle 1 from the driving configuration shown in FIG. 8 to a seating configuration and/or a transport configuration, the frame is retracted, in particular by pushing the frame parts 26, 27 together, which gives the vehicle 1 a compact outer shape, as described previously.

The frame parts 26, 27 may further each include a shield, similar to the discs 17, 18 described previously.

### LIST OF REFERENCE SIGNS

1 Vehicle
2 Wheel
3 Front wheel assembly
4 Rear wheel assembly
5 Drive device
6 Seating surface
7 Whip
8 Headrest
9 Safety bracket
10 Control device
11 Holding element
12 Adjustment device
13 Front vehicle section
14 Rear vehicle section
15 Base frame
16 Seat frame
17 Lower disc
18 Upper disc
19 Support device
20 Wing
21 Pedal crank arrangement
22 Pedal
23 Chain wheel
24 Chain
25 Chain pinion
26 Rear frame part
27 Front frame part

1. A vehicle, in particular a lightweight vehicle, with a front wheel assembly having at least one wheel, with a rear wheel assembly having at least one wheel, and with a drive device for independent movement of the vehicle,
wherein the vehicle is reversibly transferable from a driving configuration to a seating configuration, wherein the vehicle comprises a seating surface in the seating configuration and wherein the distance between the front wheel assembly and the rear wheel assembly of the vehicle is smaller in the seating configuration than in the driving configuration.

2. The vehicle according to claim 1, wherein an adjustment device is provided for changing the distance between the front wheel assembly and the rear wheel assembly.

3. The vehicle according to claim 1, wherein the vehicle is further transferable into a transport configuration, preferably wherein the distance between the front wheel assembly and the rear wheel assembly is smaller in the transport configuration than in the seating configuration.

4. The vehicle of claim 1, wherein the front wheel assembly is associated with a front vehicle section and the rear wheel assembly is associated with a rear vehicle section.

5. The vehicle according to claim 4, wherein the front vehicle section and the rear vehicle section are connected to each other in an articulated manner.

6. The vehicle according to claim 4, wherein the front vehicle section and the rear vehicle section are displaceably connected to each other.

7. The vehicle according to claim 4, wherein the front vehicle section has an arcuate base frame and/or the rear vehicle section has an arcuate adjustment device and/or an arcuate seat frame.

8. The vehicle according to claim 1, wherein the drive device comprises an electric motor and/or wherein a fuel cell and/or a photovoltaic device is assigned to the drive device.

9. The vehicle of claim 1, wherein the vehicle is designed for biomechanically driven locomotion, preferably by means of a pedal crank arrangement.

10. The vehicle of claim 1, wherein the drive device is suitable for accelerating the vehicle to a speed of at least 5 km/h, preferably at least 10 km/h, preferably at least 25 km/h, particularly preferably at least 45 km/h.

11. The vehicle of claim 1, further comprising a coupling device for coupling the vehicle to a corresponding coupling receptacle, in particular a coupling receptacle of a collective transport means.

12. The vehicle of claim 1, further comprising an extendable handle element.

13. The vehicle according to claim 1, further comprising a locking device for locking at least one wheel, preferably all wheels, and preferably wherein the locking device is activatable by transferring the vehicle into the seating configuration.

14. The vehicle of claim 3, further comprising a preferably extendable or swing-out support for stabilizing the vehicle in a standing position, in particular in the transport configuration.
